(19) United States
(12) Patent Application Publication
(10) Pub. No.: US 2011/0145457 A1
(43) Pub. Date: Jun. 16, 2011

(54) APPARATUS AND METHOD FOR MEASURING THE PERFORMANCE OF EMBEDDED DEVICES

(75) Inventors: Yung-Joon JUNG, Daejeon (KR); Dong-Hyouk Lim, Daejeon (KR); Chae-Deok Lim, Daejeon (KR); Dong-Sun Lim, Daejeon (KR); Ho-Sang Ham, Daejeon (KR)

(73) Assignee: Electronics and Telecommunications Research Institute, Daejeon (KR)

(21) Appl. No.: 12/966,945

(22) Filed: Dec. 13, 2010

(30) Foreign Application Priority Data
Dec. 15, 2009 (KR) 10-2009-0124338

(51) Int. Cl. G06F 13/24

(52) U.S. Cl. 710/260

(57) ABSTRACT

The apparatus for measuring the performance of embedded devices includes: a transceiver that transmits and receives data to and from the embedded devices; an interrupt generator that generates interrupt signal; a controller that controls the interrupt generator and the transceiver to generate the interrupt signal and transmits them to the embedded devices and performs a control to calculate real-time performance when the response signal to the interrupt signal are received from the embedded device through the transceiver; and a calculator that calculates the real-time performance of the embedded devices based on the interrupt signal generating time and the response signal receiving time.

### CROSS REFERENCE TO RELATED APPLICATIONS

This application claims priority to Korean Patent Application No. 10-2009-0124338 filed on Dec. 15, 2009, the entire contents of which are herein incorporated by reference.

### BACKGROUND OF THE INVENTION

1. Field of the Invention

The present invention relates to an apparatus and a method for measuring the performance of embedded devices, and more particularly, to an apparatus and a method for measuring the performance of embedded devices that measures the performance of embedded devices in real time.

2. Description of the Related Art

The supply and demand of the embedded device has widely increased due to the rapidly spreading embedded device related service. The performance to provide several services such as moving picture reproduction, communication function, control through the Internet, etc., among services using the distributed embedded devices in real time is needed. Technologies supporting the real-time performance of a platform for the embedded device are needed due to the services requiring real-time performance of the embedded device. A need exists for a real-time performance measuring technology for the embedded device in which a technology supporting the real-time performance can be developed and applied to the embedded device.

The real-time performance measuring technology of the currently used embedded device mounts the developed real-time performance measuring program on the embedded devices to perform the real-time performance measurement. In this case, there is a problem in that the developed real-time performance measuring program should be forwardly set on the embedded devices having various kinds of CPU architectures all the time, when considering the characteristics of the embedded system. In addition, in the case of the hardware dependent real-time performance measuring program, the forward setting may not be made and in the case of performing the measurement only in the device itself, the value can be measured slight somewhat.

### SUMMARY OF THE INVENTION

The present invention proposes to solve the above problems. It is an object of the present invention to develop a technology for supporting real-time performance required in embedded devices and to provide an apparatus and a method for measuring the performance of embedded devices in order to facilitate the real-time performance measurement of the embedded device to which the developed technology is applied and to use the embedded device as a multipurpose device.

In order to achieve the above objects, according to an exemplary embodiment of the present, there is provided an apparatus for measuring the performance of embedded devices including: a transceiver that transmits and receives data to and from the embedded devices; an interrupt generator that generates interrupt signal; a controller that controls the interrupt generator and the transceiver to generate the interrupt signal and transmits them to the embedded devices and performs a control to calculate real-time performance when the response signal to the interrupt signal are received from the embedded device through the transceiver; and a calculator that calculates the real-time performance of the embedded devices based on the interrupt signal generating time and the response signal receiving time.

The transceiver includes: a transmitting module that is connected to the embedded device through a serial port or a parallel port to transmit the interrupt signal generated from the interrupt generator to the embedded device; and a receiving module that is connected to the embedded device through the network to receive the response signal to the interrupt signal from the embedded device.

The apparatus for measuring the performance of embedded devices further includes a storage unit that stores interrupt signal generating time, response signal receiving time, and an interrupt generation period setting value.

The interrupt generator generates the interrupt signal at the period of the interrupt generation period setting value.

The calculator calculates the difference value between the interrupt signal generating time and the response signal receiving time to the real-time performance of the embedded device.

The interrupt generator generates the interrupt signal including interrupt numbers.

The transceiver receives the response signal including the same interrupt number as the corresponding interrupt signal from the embedded devices.

According to another exemplary embodiment of the present invention, there is provided an apparatus for measuring the performance of embedded devices including: a transceiver that transmits and receives data to and from an interrupt generator and an embedded device; a controller that performs a control to calculate the real-time performance of the embedded device when the interrupt generating signals are received from the interrupt generator through the transceiver and the response signal to the interrupt signal generated from the interrupt generator are received from the embedded device through the transceiver; and a calculator that calculates the real-time performance of the embedded devices based on the receiving time of the interrupt generating signal and the response signal receiving time according to the control of the controller.

The transceiver is connected to the interrupt generator and the embedded device through the network to receive the interrupt generating signals from the interrupt generator and receive the response signal to the interrupt signal from the embedded device.

The apparatus for measuring the performance of embedded devices further includes a storage unit that stores interrupt generation signal receiving time and response signal receiving time.

The calculator calculates the difference value between the interrupt generation signal receiving time and the response signal receiving time to the real-time performance of the embedded device.

The transceiver receives the interrupt generating signals including the interrupt numbers from the interrupt generator and receives the response signal including the same interrupt numbers as the corresponding interrupt generating signals from the embedded device.

The controller transmits the control signal to the interrupt generator through the transceiver to generate the interrupt signal at a period of an interrupt generation period setting value.

According to yet another exemplary embodiment of the present invention, there is provided a method for measuring the performance of embedded devices including: an interrupt generating step that transmits interrupt signal to the embedded devices by the apparatus for measuring the performance of embedded devices; a response signal receiving step that receives response signal to the interrupt signal transmitted at the interrupt generating step by the apparatus for measuring the performance of embedded devices; and a performance calculating step that calculates the real-time performance of the embedded devices based on the interrupt signal generating time transmitted at the interrupt generating step and the response signal receiving time received at the response signal receiving step by the apparatus for measuring the performance of embedded devices.

The interrupt generating step generates the interrupt signal at the period of the interrupt generation period setting value by the apparatus for measuring the performance of embedded devices.

The performance calculating step calculates the difference value between the interrupt signal generating time and the response signal receiving time to the real-time performance by the apparatus for measuring the performance of embedded devices.

The interrupt generating step controls the interrupt generator to generate the interrupt at the period of the interrupt generation period setting value by the apparatus for measuring the performance of embedded devices and transmits the generated interrupt to the embedded devices and receives the interrupt generating signals from the interrupt generator.

The performance calculating step calculates the difference value between the interrupt generation signal receiving time and the response signal receiving time to real-time performance from the apparatus for measuring the performance of embedded devices.

The interrupt generation step transmits the interrupt signal including the interrupt numbers to the embedded device by the apparatus for measuring the performance of embedded devices.

The response signal receiving step receives the response signal including the same interrupt numbers as the corresponding interrupt generating signals from the embedded device by the apparatus for measuring the performance of embedded devices.

According to the exemplary embodiment of the present invention, the apparatus and method for measuring the performance of an embedded device measures the real-time performance of the embedded devices by using the external devices, thereby making it possible to easily perform the forward setting of the developed application programs. In other words, it is very difficult to forwardly set the developed real-time performance measuring program from one embedded device to another embedded device having an entirely different structure and when using the special functions (for example, real-time timer or counter) of the embedded devices, it is impossible for the embedded devices having no special functions to perform the forward setting. However, since the apparatus and method for measuring the performance of embedded devices measure the real-time performance by using a standardized serial port, a parallel port, and a network port in the general embedded device, it is difficult to perform the forward setting.

In addition, the apparatus and method for measuring the performance of embedded devices measures the real-time performance of the embedded devices by using the external devices to solve the problems such as the hardware interrupt delay time or the occurrence of other factors that cannot be measured, when only one embedded device measures the performance, thereby making it possible to maximize the real-time performance measuring precision of the embedded devices.

### BRIEF DESCRIPTION OF THE DRAWINGS

FIG. 1 is a diagram for explaining a method for measuring the performance of embedded devices according to the first exemplary embodiment of the present invention;

FIGS. 2 and 3 are a block diagram for explaining a configuration for measuring the performance of embedded devices according to the first exemplary embodiment of the present invention;

FIG. 4 is a flow chart for explaining a method for measuring the performance of embedded devices according to the first exemplary embodiment of the present invention;

FIG. 5 is a diagram for explaining an apparatus for measuring the performance of embedded devices according to a second exemplary embodiment of the present invention;

FIGS. 6 and 7 are block diagrams for explaining a configuration for measuring the performance of embedded devices according to the first exemplary embodiment of the present invention; and

FIG. 8 is a flow chart for explaining a method for measuring the performance of the embedded device according to a second exemplary embodiment of the present invention.

### DETAILED DESCRIPTION OF THE PREFERRED EMBODIMENTS

Hereinafter, exemplary embodiments of the present invention will be described in detail with reference to the accompanying drawings so that those skilled in the art may easily implement the spirit of the present invention. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention.

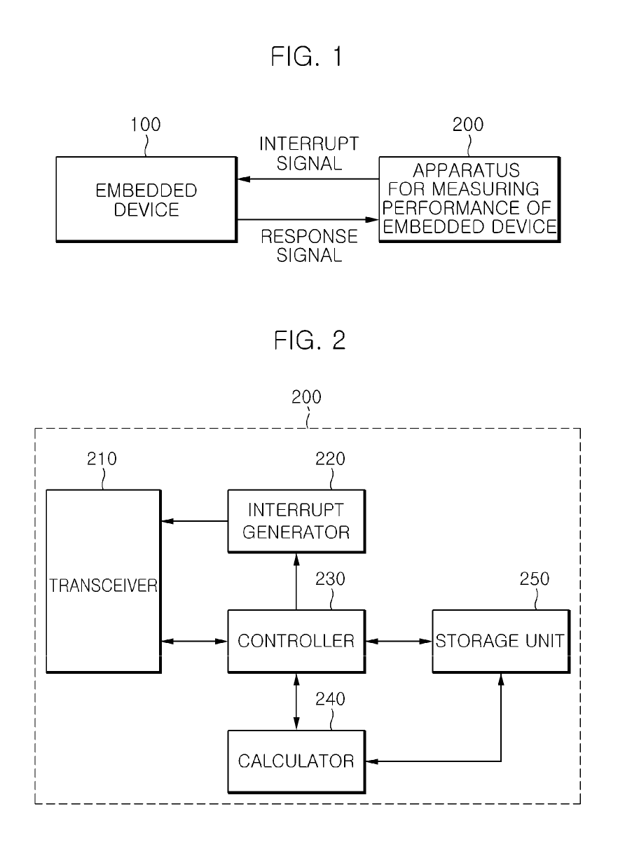

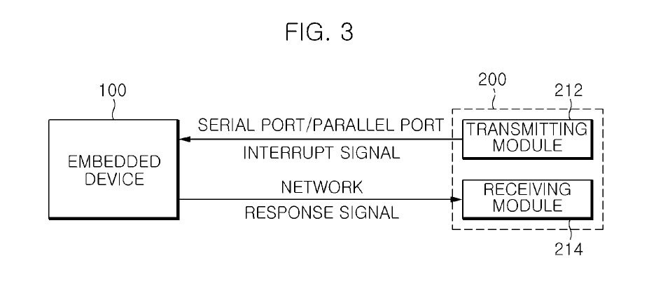

Hereinafter, an apparatus for measuring the performance of embedded devices according to a first embodiment of the present invention will be described below in more detail with reference to the accompanying drawings. FIG. 1 is a diagram for explaining an apparatus for measuring the performance of embedded devices according to a first embodiment of the present invention and FIGS. 2 and 3 are block diagrams for explaining a configuration of an apparatus for measuring the performance of embedded devices according to the first embodiment of the present invention.

As shown in FIG. 1, an apparatus 200 for measuring the performance of embedded devices is connected to an embedded device 100 in respects to a one-to-one correspondence relationship through a serial port, a parallel port, and a network port in order to measure the real-time performance of the embedded device 100. In this case, the apparatus 200 for measuring the performance of embedded devices periodically generates interrupt signal and transmits them to the embedded devices 100 through the serial port or the parallel port connection and the embedded device 100 receives the interrupt signal from the apparatus 200 for measuring the performance of embedded devices through the serial port or the parallel port connection. When the embedded device 100 monitors the serial port or the parallel port and then receives the interrupt signal, it transmits response signal to the corresponding interrupt signal through the network port and the apparatus 200 for measuring the performance of the embedded devices receives the response signal to the interrupt signal from the embedded device 100 through the network port. The apparatus 200 for measuring the performance of embedded devices measures the real-time response performance (i.e., real-time response delay time) of the embedded device 100 by using the generation time of the interrupt signal and the response signal receiving time.

As shown in FIG. 2, the apparatus 200 for measuring the performance of embedded devices includes a transceiver 210, an interrupt generator 220, a controller 230, a calculator 240, and a storage unit 250.

The transceiver 210 transmits and receives data to and from the embedded device 100. In other words, the transceiver 210 transmits the interrupt signal generated from the interrupt generator 220 to the embedded device 100 through the serial port or the parallel port. The transceiver 210 receives the response signal to the interrupt signal from the embedded device 100 through the network port. In this case, the transceiver 210 receives the response signal including the same interrupt numbers as the corresponding interrupt signal from the embedded device 100. Herein, the interrupt numbers included in the response signal are set by the embedded device 100. In other words, the embedded device 100 detects the interrupt numbers included in the received interrupt signal and generates the response signal to the corresponding interrupt signal to include the detected interrupt numbers. Therefore, the transceiver 210 receives the response signal including the interrupt numbers. To this end, as shown in FIG. 3, the transceiver 210 includes a transmitting module 212 that is connected to the embedded device 100 through one of the serial port and the parallel port to transmit the interrupt signal generated from the interrupt generator 220 to the embedded device 100 and a receiving module 214 that is connected to the embedded device 100 through a network to receive the response signal to the interrupt signal from the embedded device 100.

The interrupt generator 220 generates the interrupt signal according to the control of the controller 230. In other words, the interrupt generator 220 generates the interrupt signal at a period of an interrupt generation period setting value according to the control of the controller 230. Herein, the interrupt generation period setting value may be set during a process of generating the apparatus 200 for measuring the performance of embedded devices and may be changed by a manager. At this time, the interrupt generator 220 generates the interrupt signal including the interrupt numbers. In other words, the interrupt generator 220 generates the interrupt signal including the interrupt numbers so that each interrupt signal is separate from other interrupt signal.

The controller 230 controls the interrupt generator 220 and the transceiver 210 to generate the interrupt signal and transmit them to the embedded device 100. In other words, the controller 230 controls the interrupt generator 220 to generate the interrupt signal including the interrupt numbers. The controller 230 controls the transceiver 210 to transmit the interrupt signal generated from the interrupt generator 220 to the embedded device 100.

When the controller 230 receives the response signal to the interrupt signal from the embedded device 100 through the transceiver 210, it executes the control to calculate real-time performance. In other words, the controller 230 controls the calculator 240 to calculate real-time performance of the embedded device 100 by using the interrupt signal generating time (that is, the time taken to transmit the interrupt signal to the embedded device 100) and the response signal receiving time. At this time, the controller 230 may include a time measuring module (not shown) for measuring the interrupt signal generating time and the response signal receiving time. Of course, the controller 230 starts the time measurement when the interrupt signal is generated and ends the time measurement when the response signal is received, thereby making it possible to count the time from the generation of the interrupt signal to the receiving of the response signal.

The calculator 240 calculates the real-time performance of the embedded device 100 based on the interrupt signal generating time and the response signal receiving time according to the control of the controller 230. At this time, the calculator 240 calculates the difference value between the interrupt signal generating time and the response signal receiving time to the real-time performance of the embedded device 100.

The storage unit 250 stores the interrupt signal generating time, the receiving time of the response time, and the interrupt generation period setting value. In other words, the storage unit 250 stores the interrupt signal generating time that is a time transmitting the interrupt signal to the embedded device 100. The storage unit 250 stores the response signal receiving time that is the time taken to receive the response signal to the interrupt signal from the embedded device 100. The storage unit 250 stores the interrupt generation period setting value for setting the interrupt generation period.

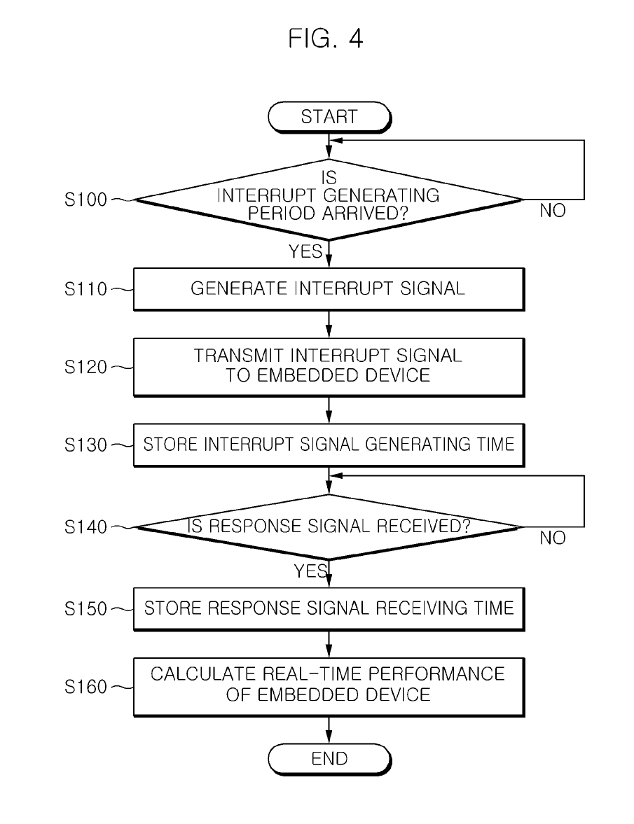

Hereinafter, the apparatus for measuring the performance of embedded devices according to the first embodiment of the present invention will be described below in more detail with reference to the accompanying drawings. FIG. 4 is a flow chart for explaining the method for measuring the performance of the embedded device according to the first exemplary embodiment of the present invention.

If the interrupt generation period arrives (S100; YES), the controller 230 controls the interrupt generator 220 to generate the interrupt signal. As a result, the interrupt generator 220 generates the interrupt signal (S110). In this case, the interrupt generator 220 generates the interrupt signal including the interrupt numbers so that each interrupt signal is separate from other interrupt signal.

The controller 230 controls the transceiver 210 to transmit the interrupt signal generated from the interrupt generator 220 to the embedded device 100. As a result, the transceiver 210 transmits the interrupt signal generated from the interrupt generator 220 to the embedded device 100 (S120). In this case, the transceiver 210 transmits the interrupt signal to the embedded device 100 through the serial port or the parallel port.

Next, the controller 230 stores the time taken to transmit the interrupt signal to the embedded device 100 as the interrupt signal generating time (S130).

Thereafter, if the transceiver 210 receives the response signal from the embedded device 100 (S140: YES), the controller 230 stores the time taken to receive the response signal as the response signal receiving time (S140).

The controller 230 controls the calculator 240 to calculate the real-time performance of the embedded device 100 by using the stored interrupt signal generating time and the response signal receiving time. As a result, the calculator 240 calculates the difference value between the interrupt signal generating time and the response signal receiving time as the real-time performance of the embedded device 100 (S160).

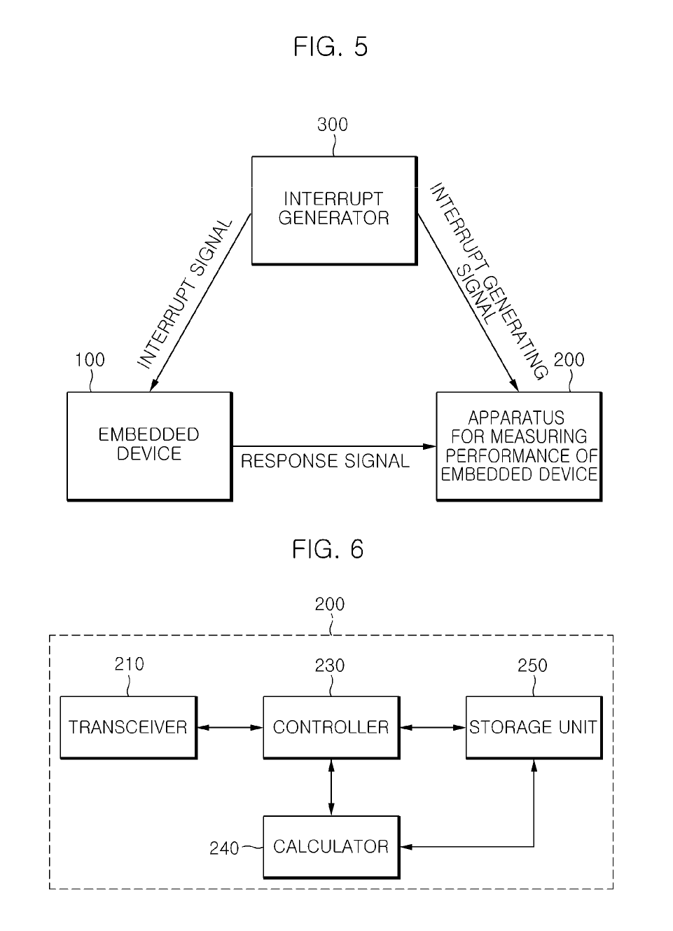

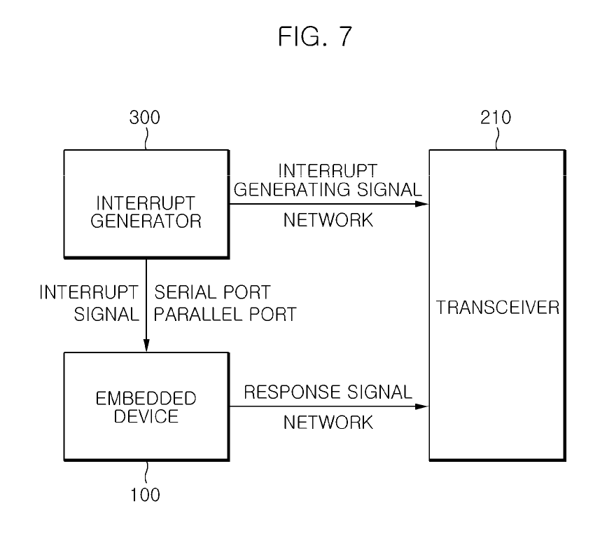

Hereinafter, an apparatus for measuring the performance of embedded devices according to a second embodiment of the present invention will be described below in more detail with reference to the accompanying drawings. FIG. 5 is a diagram for explaining an apparatus for measuring the performance of embedded devices according to a second embodiment of the present invention and FIGS. 6 and 7 are block diagrams for explaining a configuration of an apparatus for measuring the performance of embedded devices according to the second embodiment of the present invention.

As shown in FIG. 5, an apparatus 200 for measuring the performance of embedded devices is connected to the interrupt generator 300 and the embedded device 100 through a network port in order to measure the real-time performance of the embedded device 100. In this case, the interrupt generator 300 is connected to the embedded device 100 through the serial port or the parallel port. The interrupt generator 300 periodically generates the interrupt signal and transmits them to the embedded device 100 through the serial port connection or the parallel port connection. Further, the interrupt generator 300 transmits the interrupt generating signals to the apparatus 200 for measuring the performance of embedded devices through the network port. In this case, the interrupt generator 300 generates the interrupt signal including the interrupt numbers so that each interrupt signal is separate from other interrupt signal. The embedded device 100 receives the interrupt signal from the interrupt generator 300 through the serial port or the parallel port. The embedded device 100 generates the response signal to the received interrupt signal. The embedded device 100 transmits the generated response signal to the apparatus 200 for measuring the performance of embedded devices through the network port. In this case, the embedded device 100 generates the response signal including the same interrupt numbers as the interrupt numbers included in the interrupt signal received from the interrupt generator 300 and transmits them to the apparatus 200 for measuring the performance of embedded devices. The apparatus 200 for measuring the performance of embedded devices measures the real-time response performance (i.e., real-time response delay time) of the embedded device 100 by using the interrupt generation signal receiving time and the response signal receiving time.

As shown in FIG. 6, the apparatus 200 for measuring the performance of embedded devices includes the transceiver 210, the controller 230, the calculator 240, and a storage unit 250.

The transceiver 210 transmits and receives data to and from the embedded device 100 and the interrupt generator 300. In other words, the transceiver 210 is connected to the embedded device 100 and the interrupt generator 300 through the network port. The transceiver 210 receives the interrupt generating signals from the interrupt generator 300 through the network port and then receives the response signal to the interrupt signal from the embedded device 100 (see FIG. 7). At this time, the transceiver 210 receives the interrupt generating signals including the interrupt numbers from the interrupt generator 300 and the response signal including the same interrupt numbers as the corresponding interrupt generating signals from the embedded device 100.

When the controller 230 receives the interrupt generating signals and the response signal from the embedded device 100 through the transceiver 210, it controls the calculator 240 to calculate the real-time performance of the embedded device 100. In other words, the controller 230 controls the calculator 240 to calculate the real-time performance of the embedded device 100 by using the interrupt generation signal receiving time and the response signal receiving time. In this case, the controller 230 may include the time measuring module (not shown) for measuring the interrupt generation signal receiving time and the response signal receiving time. Of course, the controller 230 starts the time measurement when the interrupt generating signal is received and ends the time measurement when the response signal is received, thereby making it possible to count the time consumed from the reception of the interrupt generating signal to the reception of the response signal.

The controller 230 may transmit the control signal to the interrupt generator 300 through the transceiver 210 to generate the interrupt signal at a period of an interrupt generation period setting value. In other words, the controller 230 transmits the interrupt generation period setting value stored in the storage unit 250 separately from the interrupt generation period set in the interrupt generator 300 to the interrupt generator 300 through the transceiver 210 to change the interrupt signal generation period in the interrupt generator 300.

The calculator 240 calculates the real-time performance of the embedded device 100 based on the receiving time of the interrupt signal and the response signal according to the control of the controller 230. In other words, the calculator 240 calculates the difference value between the interrupt generation signal receiving time and the response signal receiving time by the real-time performance of the embedded device 100.

The storage unit 250 stores the interrupt generation signal receiving time and the response signal receiving time. The storage unit 250 may further store the interrupt generation period setting value. In other words, the storage unit 250 stores the interrupt generation signal receiving time that is a time receiving the interrupt generating signal from the interrupt generator 300. The storage unit 250 stores the response signal receiving time that is the time taken to receive the response signal to the interrupt signal from the embedded device 100. The storage unit 250 stores the interrupt generation period setting value for setting the interrupt generation period of the interrupt generator 300.

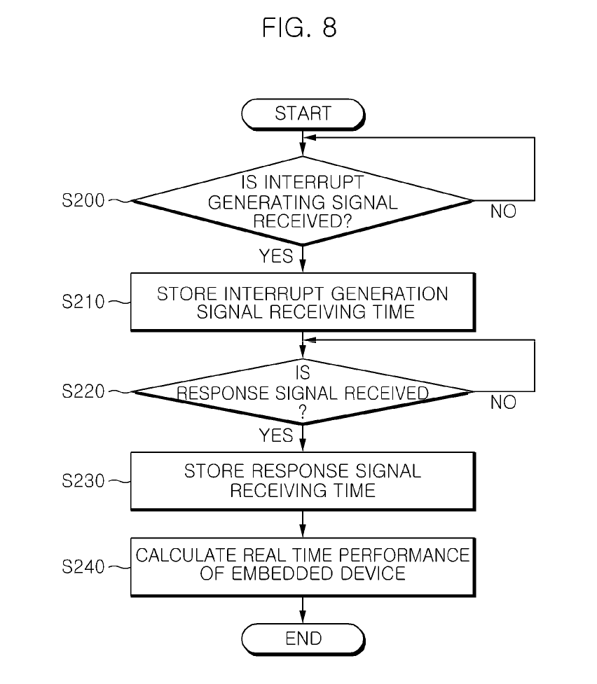

Hereinafter, the apparatus for measuring the performance of embedded devices according to the second embodiment of the present invention will be described below in more detail with reference to the accompanying drawings. FIG. 8 is a flow chart for explaining the method for measuring the performance of the embedded device according to the second exemplary embodiment of the present invention. First, the interrupt generator 300 transmits the interrupt signal to the embedded device 100 at a previously set period interval. In this case, the interrupt generator 300 transmits the interrupt signal to the embedded device 100 through the serial communication port or the parallel port. Simultaneously, the interrupt generator 300 transmits the interrupt generating signal to the transceiver 210 in the apparatus for measuring the device performance in order to inform the apparatus 200 for measuring the performance of embedded devices the generation of the interrupt signal.

If the transceiver 210 receives the interrupt generating signal from the interrupt generator 300 (S200; YES), the controller 230 stores the time taken to receive the interrupt generating signal as the interrupt generation signal receiving time (S210).

Thereafter, if the transceiver 210 receives the response signal from the embedded device 100 (S220: YES), the controller 230 stores the time taken to receive the response signal as the response signal receiving time (S230).

The controller 230 controls the calculator 240 to calculate the real-time performance of the embedded device 100 by using the stored interrupt generation signal receiving time and the response signal receiving time. As a result, the calculator 240 calculates the difference value between the interrupt generation signal receiving time and the response signal receiving time by the real-time performance of the embedded device 100 (S240).

As described above, the apparatus and method for measuring the performance of embedded devices measures the real-time performance of the embedded devices 100 by using external devices to easily perform the forward setting of the developed application programs and to solve the problems such as the hardware interrupt delay time or the occurrence of other factors that cannot be measured, when only one embedded device measures the performance, thereby making it possible to maximize the real-time performance measuring precision of the embedded devices.

Although exemplary embodiments of the present invention have been described, it will be appreciated by those skilled in the art that various modifications and changes may be made without departing from the appended claims of the present invention.

What is claimed is:

1. An apparatus for measuring the performance of embedded devices, comprising:
a transceiver that transmits and receives data to and from the embedded devices;
an interrupt generator that generates interrupt signal;
a controller that controls the interrupt generator and the transceiver to generate the interrupt signal and transmit them to the embedded devices and performs a control to calculate real-time performance when the response signal to the interrupt signal are received from the embedded device through the transceiver; and
a calculator that calculates the real-time performance of the embedded devices based on the interrupt signal generating time and the response signal receiving time according to the control of the controller.

2. The apparatus for measuring the performance of embedded devices according to claim 1, wherein the transceiver includes:
a transmitting module that is connected to the embedded device through a serial port or a parallel port to transmit the interrupt signal generated from the interrupt generator to the embedded device; and
a receiving module that is connected to the embedded device through the network to receive the response signal to the interrupt signal from the embedded device.

3. The apparatus for measuring the performance of embedded devices according to claim 1, further comprising a storage unit that stores interrupt signal generating time, response signal receiving time, an interrupt generation period setting value.

4. The apparatus for measuring the performance of embedded devices according to claim 1, wherein the interrupt generator generates the interrupt signal at the period of the interrupt generation period setting value.

5. The apparatus for measuring the performance of embedded devices according to claim 1, wherein the calculator calculates the difference value between the interrupt signal generating time and the response signal receiving time to the real-time performance of the embedded device.

6. The apparatus for measuring the performance of embedded devices according to claim 1, wherein the interrupt generator generates the interrupt signal including interrupt numbers.

7. The apparatus for measuring the performance of embedded devices according to claim 1, wherein the transceiver receives the response signal including the same interrupt number as the corresponding interrupt signal from the embedded devices.

8. An apparatus for measuring the performance of embedded devices, comprising:
a transceiver that transmits and receives data to and from an interrupt generator and an embedded device;
a controller that performs a control to calculate the real-time performance of the embedded device when the interrupt generating signals are received from the interrupt generator through the transceiver and the response signal to the interrupt signal generated from the interrupt generator are received from the embedded device through the transceiver; and
a calculator that calculates the real-time performance of the embedded devices based on the receiving time of the interrupt generating signal and the response signal receiving time according to the control of the controller.

9. The apparatus for measuring the performance of embedded devices according to claim 8, wherein the transceiver is connected to the interrupt generator and the embedded device through the network to receive the interrupt generating signals from the interrupt generator and receive the response signal to the interrupt signal from the embedded device.

10. The apparatus for measuring the performance of embedded devices according to claim 8, further comprising a storage unit that stores interrupt generation signal receiving time and response signal receiving time.

11. The apparatus for measuring the performance of embedded devices according to claim 8, wherein the calculator calculates the difference value between the interrupt generation signal receiving time and the response signal receiving time to the real-time performance of the embedded device.

12. The apparatus for measuring the performance of embedded devices according to claim 8, wherein the transceiver receives the interrupt generating signals including the interrupt numbers from the interrupt generator and receives the response signal including the same interrupt numbers as the corresponding interrupt generating signals from the embedded device.

13. The apparatus for measuring the performance of embedded devices according to claim 8, wherein the controller transmits the control signal to the interrupt generator through the transceiver to generate the interrupt signal at a period of an interrupt generation period setting value.

14. A method for measuring the performance of embedded devices, comprising:
an interrupt generating step that transmits interrupt signal to the embedded devices by the apparatus for measuring the performance of embedded devices;
a response signal receiving step that receives response signal to the interrupt signal transmitted at the interrupt generating step by the apparatus for measuring the performance of embedded devices; and
a performance calculating step that calculates the real-time performance of the embedded devices based on the interrupt signal generating time transmitted at the interrupt generating step and the response signal receiving time received at the response signal receiving step by the apparatus for measuring the performance of embedded devices.

15. The method for measuring the performance of embedded devices according to claim 14, wherein the interrupt generating step generates the interrupt signal at the period of the interrupt generation period setting value by the apparatus for measuring the performance of embedded devices.

16. The method for measuring the performance of embedded devices according to claim 14, wherein the performance calculating step calculates the difference value between the interrupt signal generating time and the response signal receiving time to the real-time performance by the apparatus for measuring the performance of embedded devices.

17. The method for measuring the performance of embedded devices according to claim 14, wherein the interrupt generating step controls the interrupt generator to generate the interrupt at the period of the interrupt generation period setting value and transmits the generated interrupt to the embedded devices, and receives the interrupt generating signals from the interrupt generator by the apparatus for measuring the performance of embedded devices.

18. The method for measuring the performance of embedded devices according to claim 17, wherein the performance calculating step calculates the difference value between the interrupt generation signal receiving time and the response signal receiving time to the real-time performance by the apparatus for measuring the performance of embedded devices.

19. The method for measuring the performance of embedded devices according to claim 14, wherein the interrupt generation step transmits the interrupt signal including the interrupt numbers to the embedded device by the apparatus for measuring the performance of embedded devices.

20. The method for measuring the performance of embedded devices according to claim 14, wherein the response signal receiving step receives the response signal including the same interrupt numbers as the corresponding interrupt generating signals from the embedded device by the apparatus for measuring the performance of embedded devices.
